(19) United States
(12) Patent Application Publication
(10) Pub. No.: US 2014/0239060 A1
(43) Pub. Date: Aug. 28, 2014

(54) MAINTENANCE ARRANGEMENT FOR AN ANALYSIS DEVICE

(71) Applicant: Frank Thomas, Solingen (DE)

(72) Inventor: Frank Thomas, Solingen (DE)

(73) Assignee: HACH LANGE GMBH, BERLIN (DE)

(21) Appl. No.: 14/349,073

(22) PCT Filed: Oct. 4, 2011
(86) PCT No.: PCT/EP2011/067307

§ 371 Date: Apr. 2, 2014

(51) Int. Cl. H04W 76/02; G06K 7/10

(52) U.S. Cl. CPC H04W 76/021; G06K 7/10821
USPC 235/375

(57) ABSTRACT

A maintenance arrangement for an analysis device for maintaining an environment analysis device includes an environment analysis device, a radio station and a mobile service device. The environment analysis device comprises a manual input, a monitor, and a barcode generator configured to generate a barcode comprising a virtual target address for display on the monitor from an input information item. The service device comprises a digital camera configured to read the barcode, a barcode reading module configured to extract the virtual target address from the barcode read by the digital camera, and a radio module configured to establish a radio link to the radio station and to transmit the virtual target address to the radio station. The radio station is configured to connect the service device to a target device comprising a target address.

### CROSS REFERENCE TO PRIOR APPLICATIONS

This application is a U.S. National Phase application under 35 U.S.C. §371 of International Application No. PCT/EP2011/067307, filed on Oct. 4, 2011. The International Application was published in German on Apr. 11, 2013 as WO 2013/050063 A1 under PCT Article 21(2).

### FIELD

The present invention relates to a maintenance arrangement for an analysis device for the maintenance of an environment analysis device.

### BACKGROUND

Environment analysis devices serve to qualitatively and quantitatively determine certain analytes in an air or water sample. Modern environment analysis devices are digitally controlled and store a large amount of information for the purposes of device maintenance and an error-free and precise determination of analytes, such as data about the analysis device itself, the sensor type or sensor used, error reports, information about the chemicals used, such as a batch number, and the like. Only important primary information items are generally stored in the memory of the analysis device, but not secondary information that are rarely needed, such as a comprehensive manual in a foreign language, safety data sheets, general information about reagent quality, and the like. Such secondary information are possibly retrievable from an Internet sever of the manufacturer of the analysis device, if at all.

In some instances, modern environment analysis devices are linked to an internal and/or even an external digital network so that a direct link to the analysis device can be established via the network link to read out the above-mentioned information.

Device maintenance is generally performed using a mobile digital service device that must be connected to the analysis device via a data link to read out the primary information. For this purpose, the analysis device must have corresponding hardware and software and a suitable link must first be established between the service device and the analysis device.

### SUMMARY

An aspect of the present invention is to facilitate the handling of a maintenance arrangement for an analysis device for the maintenance of an environment analysis device by means of a service device.

In an embodiment, the present invention provides a maintenance arrangement for an analysis device for maintaining an environment analysis device which includes an environment analysis device, a radio station and a mobile service device. The environment analysis device comprises a manual input, a monitor, and a barcode generator configured to generate a barcode comprising a virtual target address for display on the monitor from an input information item. The service device comprises a digital camera configured to read the barcode, a barcode reading module configured to extract the virtual target address from the barcode read by the digital camera, and a radio module configured to establish a radio link to the radio station and to transmit the virtual target address to the radio station. The radio station is configured to connect the service device to a target device comprising a target address.

### BRIEF DESCRIPTION OF THE DRAWINGS

The present invention is described in greater detail below on the basis of embodiments and of the drawings in which:

FIG. 1 shows a maintenance arrangement for an analysis device 10, which is substantially comprised of a stationary environment analysis device 12, a mobile service device 14, a radio station 16 and an Internet server 18.

### DETAILED DESCRIPTION

The stationary environment analysis device comprises a manual input means, a monitor and a barcode generator. Modern environment analysis devices are generally already serially equipped with a monitor and a manual input means. The monitor is configured so that it can display a barcode with sufficient resolution.

A manual input means is understood to comprise any type of a human/machine interface, in particular keys and keyboards, which may be configured to be mechanical and separate from the monitor, but may also be configured as corresponding keypads on a monitor designed as a so-called touchscreen.

The barcode generator generates a barcode from input information and displays the barcode on the monitor. The barcode always includes a unique virtual target address, in particular an Internet target address.

The mobile service device comprises a digital camera, a barcode reading module and a radio module for establishing a radio link to a stationary radio station. The digital camera has a resolution making it possible to take a picture of the barcode displayed on the monitor with sufficient resolution. From the barcode captured by the digital camera from the monitor of the analysis device, the barcode reading module extracts the virtual target address there displayed. The service device is thereafter linked via a data link to a target device having the target address.

The radio module is suited for establishing a link to a stationary external radio station which can, for example, be effected via a mobile phone link or a mobile data link such as, for example, EDGE, GRPS or UMTS, but also via an internal radio link using WLAN, Bluetooth or other radio networks.

In an embodiment of the method of the present invention a manual operation of the input means is first provided, whereby the barcode generator generates a barcode containing a virtual target address. By operation of the input means, such as a key, the service technician calls for specific information, such as a manual for the analysis device, calibration data of the reagents and/or sensors used, safety data sheets regarding the reagents used, basic data and maintenance information about the analysis device, error patterns or error rectification information, and the like.

The analysis device stores a list of the virtual target addresses at which the information offered are directly available. The target addresses are in particular Internet addresses at which the manufacturer of the analysis device or of the reagents provides corresponding information. This virtual target address is generated by the barcode generator as a barcode that is displayed on the monitor. Instead of the target address, it is of course possible to store the barcode in the list that already includes the relevant target address.

The service technician captures the barcode on the monitor of the analysis device using the digital camera of his mobile service device. From this captured barcode, the barcode reading module of the service device determines the virtual target address which is transmitted by the radio module of the service device to the stationary radio station that retransmits the information stored at the target address to the service device so that this information can be displayed on a monitor of the service device.

If the analysis device is connected directly to an internal and/or even an external digital network, the analysis device has its own virtual address via which it can be addressed directly. In this case, the service technician can request a direct link to the analysis device via the manual input means of the analysis device, whereupon the barcode generator generates a barcode with the virtual analysis device address as the target address and causes the same to be displayed on the monitor of the analysis device. The mobile service device sends the virtual target address that corresponds to the virtual address of the analysis device to the stationary radio station which will then cause a link to be established between the service device and the analysis device. A data link is established in this manner between the service device and the analysis device, without the analysis device necessarily having to be provided with special hardware and software for a direct link between the analysis device and the service device.

In an embodiment of the present invention, the barcode can, for example, be a two-dimensional barcode, and the monitor can, for example, have a resolution of more than 127 pixels along both axes. Only a two-dimensional barcode allows the representation of longer target addresses, as is generally true, for example, for the Internet address of a device manufacturer at which a manual for the analysis device is stored. The monitor of the analysis device should have a certain minimum resolution to allow reading a two-dimensional barcode with a grid of at least 50×50 dots.

In an embodiment of the present invention, the analysis device can, for example, be a stationary analysis device, wherein the analysis device can be a laboratory analysis device for performing single measurements or a process analysis device for a quasi-continuous measurement for monitoring a process. The analysis device can, for example, be a water analysis device used to determine an analyte in water, for example, drinking water, service water or waste water.

The following is a detailed description of an embodiment of the present invention with reference to the drawing.

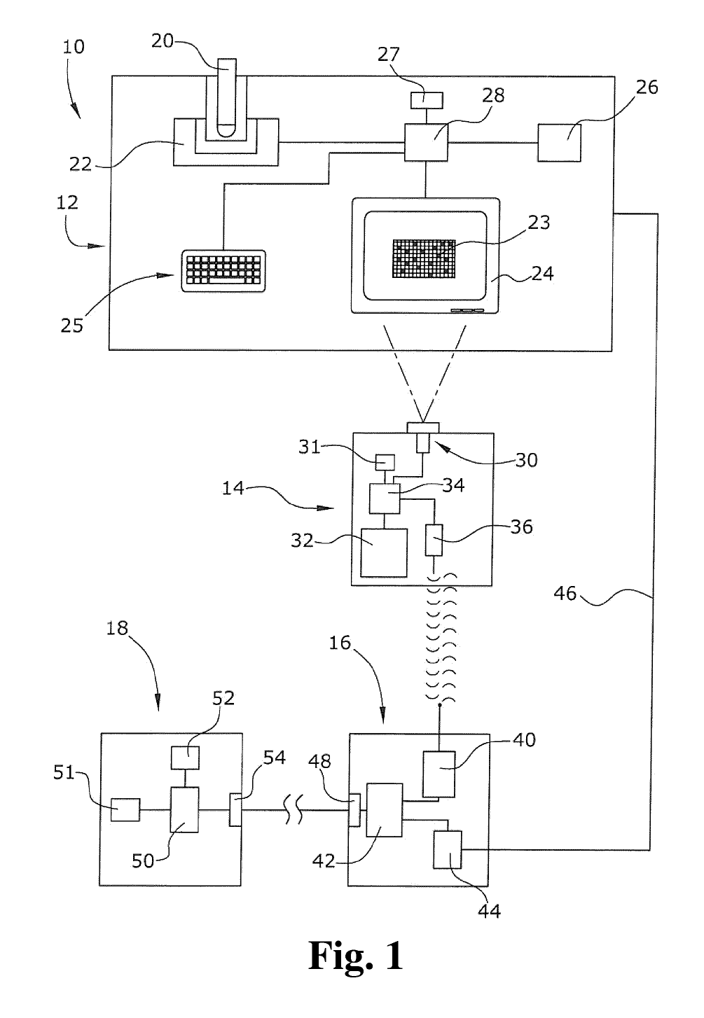

An embodiment of the maintenance arrangement 10 is shown in FIG. 1. In the present case, the environment analysis device 12 is a stationary laboratory analysis device for the analysis of an analyte in a water sample that has been pipetted into a cuvette 20 containing a reagent. The cuvette 20 stands in a cuvette shaft to which a photometer 22 is associated which performs photometry thereon in a radial direction. The analysis device 12 has an input means 25 in the form of a small keyboard, a LCD monitor 24, a data memory 26, and a barcode generator 27. All of the above-mentioned aggregates of the analysis device 12 are controlled and regulated by a central control 28. The monitor 24 has a resolution of at least 128×128 dots.

The data memory 26 stores device information, such as the serial number of the analysis device 12, sensor information about the sensor 22 installed, which in the shown embodiment is the photometer 22, a batch number of the cuvette 20 or the reagent in the cuvette 20, device error reports, maintenance information, etc. The information stored in the data memory 26 can be converted into a barcode 23 by the barcode generator 27 together with the request for information inputted by the service technician via the input means 25, the barcode 23 including a virtual target address. In the shown embodiment, the virtual target address is an Internet address at which the inputted request for information can be retrieved directly for the respective analysis device 12, the respective sensor 22, the respective reagent and/or the respective reagent batch.

The mobile service device 14 comprises a digital camera 30, a barcode reading module 31, a radio module 36, a display 32 configured as a monitor, and a control 34. The digital camera 30 has a resolution that should at least be twice as high as the resolution of the monitor 24. The barcode reading module 31 serves to determine the information stored in the barcode from the picture taken by the digital camera 30 of the barcode 23 displayed on the monitor 24 of the analysis device 12, and, in particular, to determine an Internet target address stored in the barcode 23. The barcode reading module 31 is not necessarily a separate hardware module, but may also be implemented exclusively in the software stored in the data memory 26.

In the present case, the radio module 36 is a mobile phone radio module adapted to establish a wireless data link to a corresponding stationary radio station 16. Useful standards are presently GSM, HSCSD, GPRS, EDGE or UMTS mobile phone networks.

Alternatively or additionally, the radio module 36 may also be designed as a WLAN module, whereby the service device can also establish a data link to a local wireless network. This is only feasible, however, if the analysis device 12 is connected to the WLAN radio station 16 via a network data line 46.

The stationary radio station 16 comprises a radio module 40, an analysis device interface 44, an Internet interface 48 and a central control 42. Via the analysis device interface 44, the stationary radio station 16 is directly connected to the analysis device 12 through a network data link 46, for example, an Ethernet link. The Internet interface 48 connects the radio station 16 to an Internet server 18.

The Internet server 18 is situated, for example, at the manufacturer of the analysis device 12. The Internet server 18 has an interface 54, a control 50, a first data memory 51 and a second data memory 52. Among other things, the first data memory 51 stores information about the analysis device 12 under its serial number, such as manuals, technical and historical data of the analysis device, etc. The second data memory 52 stores batch-specific information about the reagent in the cuvette 20, such as calibration data, expiration dates, information on hazards, etc. Each of the information items mentioned is stored at a unique target address so that the information stored there can immediately be retrieved at this target address.

When a service technician wants a certain piece of information, he first enters his request for information, i.e., the type of the desired information, into the analysis device 12 via the keyboard as an input means 25. The central control 28 retrieves the device and/or reagent information required for the concrete request for information from the data memory 26, then sends them to the barcode generator 27 which generates a unique Internet address from the same and converts it into a two-dimensional barcode 23. The control sends this barcode 23 to the monitor 24 so that the barcode 23 containing the Internet target address is displayed on the monitor 24.

The service technician captures the barcode 23 on the monitor 24 with the digital camera 30 of his mobile service device 14. The control 34 sends the photo with the captured barcode 23 to the barcode reading module 31 that extracts the Internet address from the barcode. The control 34 causes the radio module 36 to establish a data link to a stationary radio station 16. As soon as the data link is established, the radio module 36 sends the Internet address to the radio station 16 that establishes a link to the relevant Internet address on the Internet server 18 and returns the information stored on the Internet server 18 at this Internet address to the service device 14, where this information is displayed on the display 32.

The present invention is not limited to embodiments described herein; reference should be had to the appended claims.

What is claimed is:

1-6. (canceled)

7. A maintenance arrangement for an analysis device for maintaining an environment analysis device, the maintenance arrangement comprising:
an environment analysis device comprising:
a manual input,
a monitor, and
a barcode generator configured to generate a barcode comprising a virtual target address for display on the monitor from an input information item;
a radio station; and
a service device configured to be mobile, the service device comprising:
a digital camera configured to read the barcode,
a barcode reading module configured to extract the virtual target address from the barcode read by the digital camera, and
a radio module configured to establish a radio link to the radio station and to transmit the virtual target address to the radio station,
wherein, the radio station is configured to connect the service device to a target device comprising a target address.

8. The maintenance arrangement as recited in claim 7, wherein the barcode is a two-dimensional barcode.

9. The maintenance arrangement as recited in claim 7, wherein the monitor has a resolution higher than 127 pixels along both of its axes.

10. The maintenance arrangement as recited in claim 7, wherein the environment analysis device is a stationary analysis device.

11. The maintenance arrangement as recited in claim 7, wherein the environment analysis device is a water analysis device.

12. A mobile service device for an environment analysis device, the mobile service device comprising:
a digital camera configured to read a barcode;
a barcode reading module configured to extract a virtual target address from the barcode read by the digital camera; and
a radio module configured to establish a radio link to a radio station and to transmit the virtual target address to the radio station.

13. A method for maintaining an environment analysis device of a maintenance arrangement for an analysis device, the method comprising:
providing an environment analysis device comprising:
a manual input,
a monitor, and
a barcode generator configured to generate a barcode comprising a virtual target address for display on the monitor from an input information item,
providing a mobile service device comprising:
a digital camera,
a barcode reading module, and
a radio module configured to establish a radio link to a radio station,
manually operating the manual input so that the barcode generator generates the barcode containing the virtual target address;
displaying the barcode on the monitor;
taking a picture of the monitor displaying the barcode with the digital camera so as to capture the barcode;
extracting the virtual target address from the captured barcode with the barcode reading module;
sending the virtual target address to the radio station via the radio module; and
linking the mobile service device to a target device having a target address via the radio station.
